(19) United States
(12) Patent Application Publication
(10) Pub. No.: US 2010/0019072 A1
(43) Pub. Date: Jan. 28, 2010

(54) LAND APPLICATION VEHICLE, LOADING APPARATUS AND MATERIAL HANDLING SYSTEM AND METHOD FOR SEMI-SOLID MATERIAL

(76) Inventor: Dennis Nuhn, Sebringville (CA)

Correspondence Address: BRUNET & CO. LTD., 10712 MELROSE DR., KOMOKA, ON, N0L-1R0, CA

(21) Appl. No.: 12/505,499

(22) Filed: Jul. 19, 2009

Related U.S. Application Data
(60) Provisional application No. 61/083,903, filed on Jul. 25, 2008.

(51) Int. Cl. A01C 3/06; B65G 65/00

(52) U.S. Cl. 239/675; 239/677; 239/663; 414/310; 414/808

(57) ABSTRACT

According to an aspect of the invention, there is provided a land application vehicle for a semi-solid material, such as bio-solids. The vehicle includes a hopper and a distributor. The distributor includes a housing having a distributor inlet and at least one distributor outlet, a first distributor auger in the housing configured for transferring semi-solid material away from the distributor inlet towards the at least one distributor outlet and a second distributor auger in the housing configured for transferring semi-solid material back towards the distributor inlet. This creates re-circulation of the semi-solid material within the distributor, which inhibits packing of the semi-solid material at the ends of the distributor and generally aids in uniform distribution of the material.

### CROSS REFERENCE TO RELATED APPLICATIONS

This application claims the benefit of U.S. patent application 61/083,903, filed on Jul. 25, 2008, which is incorporated herein by reference.

### FIELD OF THE INVENTION

The present invention relates to the application of semi-solid material to land, and more particularly to a vehicle for the application of bio-solids to farmland.

### BACKGROUND OF THE INVENTION

In the treatment of wastewater, either from industrial, agricultural or municipal sources, bio-solids or sludge are produced. One of the main problems in wastewater treatment is the environmentally safe and economic disposal of sludge.

One of the more favored methods of sludge disposal is by application onto agricultural land. In one such method, sludge is removed from a wastewater treatment plant in a highly liquid state and spread on to the land using a vehicle equipped with pumps that spray the sludge outward of the vehicle or, in some cases, inject the sludge into the soil using a toothed applicator. Similar types of vehicles are employed in the application of liquid animal manure. An example of such a vehicle is described in commonly owned US patent publication 2005/0061836.

One problem with this approach is that the sludge has a very high water content, which increases the shipping weight of the sludge. It is desirable to reduce the shipping weight by transporting de-watered sludge. One difficulty with this approach is that the sludge is no longer amenable to handling by pumping, so different handling and land application equipment is required.

A conventional manure spreader, for handling predominantly solid animal manure, comprises a moving chain in the bottom of the spreader and a pair of rotating spreader elements in the rear. The manure is broadcast rearwardly of the spreader and applied on top of the soil. Examples of such spreaders are provided in U.S. Pat. No. 3,123,363, U.S. Pat. No. 4,220,280, U.S. Pat. No. 5,199,638 and U.S. Pat. No. 5,386,943. However, even when de-watered, the solids content of the sludge is lower than that of solid animal manure (i.e. there is still too much water) and would therefore not be suitable for application using a conventional manure spreader.

Accordingly, a different type of vehicle is required to apply de-watered bio-solids (or similar semi-solid materials) on agricultural land.

### SUMMARY OF THE INVENTION

According to an aspect of the invention, there is provided a land application vehicle for semi-solid material. The vehicle includes a hopper having a hopper inlet and a hopper outlet, and a distributor having a transversely oriented length comprising a housing having a distributor inlet for receiving semi-solid material from the hopper, and at least one distributor outlet, a first distributor auger in the housing for transferring semi-solid material away from the distributor inlet and a second distributor auger in the housing for returning semi-solid material back towards the distributor inlet.

In one embodiment, the vehicle may comprise a generally V-shaped hopper. The semi-solid material may be transferred to the distributor via gravity or the hopper may contain an internal longitudinal auger at its bottom apex for transferring semi-solid material (such as bio-solids) from a front to a rear of the hopper. The distributor may be located at the rear and in fluid communication with the hopper outlet, which may also be located at the rear. The hopper outlet may be located at a bottom of the hopper and the distributor may be located at least partially beneath the hopper. The distributor inlet may be centrally positioned along the length of the housing and the first distributor auger may act to transfer the semi-solid materials away from the inlet towards the ends of the housing, while the second distributor auger acts to transfer the materials from the ends of the housing back towards the distributor inlet. The distributor inlet may be in fluid communication with both the first and second distributor augers.

The distributor may comprise a pair of transverse augers that may have continuous, oppositely oriented flights; in this embodiment, the augers are co-rotated (rotated in the same direction). In an alternative embodiment, the flights are oriented in the same direction and the augers are counter-rotated (rotated in opposite directions). The mutually opposed material transfer orientation of the augers creates recirculation to prevent packing of the semi-solid material within the distributor housing and the associated power loss and uneven distribution of semi-solid material that would result therefrom.

The first distributor auger may be positioned within the housing and configured for transferring the semi-solid materials towards the distributor outlet. In one embodiment, only the first distributor auger is so positioned and configured. The augers may or may not be intermeshing; intermeshing is advantageous in that it creates additional shear and aids in creating recirculation and self-cleaning of the augers. The first distributor auger may be located slightly below and rearward of the second distributor auger. The distributor outlet may comprise a plurality of discrete openings (e.g. five openings) provided in the bottom of the distributor housing evenly transversely spaced along the length of the distributor and proximal the first distributor auger in order that the semi-solid material can fall out on top of the ground beneath the distributor.

The speed of the augers may be adjusted to obtain distribution of the solids along the distributor, while at the same time creating enough shear to force the solids out through the distributor outlet. The speed adjustment may take into account the application rate and the quality of the semi-solid material (in terms of stickiness and water content). In one embodiment, each auger may be rotated at a different speed. The first distributor auger may rotate at a slower rate than that of the second distributor auger. The speed of the two augers may be adjusted in order to provide even distribution of semi-solid materials along the distributor while at the same time providing the desired amount of recirculation to prevent packing of the semi-solid material at the ends of the housing.

A soil incorporator may be optionally installed rearward of the applicator that comprises a plurality of earth working tools positioned and configured for covering the semi-solid material discharged onto the ground through the distributor outlets with earth. The earth working tools are designed to throw dirt over top of each strip of manure discharged from the distributor outlets. In this way, the strips are covered with soil in order to minimize odour and nutrient loss. The earth working tools may comprise a plurality of coulter wheels that may comprise at least one pair of coulter wheels, the pair comprising a first coulter wheel and a second coulter wheel. There may be a rear spacing between the first and second coulter wheels that is less than a front spacing. There may be a bottom spacing between the first and second coulter wheels that is less than a top spacing. This advantageously allows the incorporator to throw a sufficient amount of dirt to cover the semi-solid materials, without overly working the soil or creating too great of a power requirement for the vehicle towing implement.

It should be noted that dewatered bio-solids are semi-solid and have a water content of about 35-50%, giving them a thick consistency similar to cement. This is not analogous to the consistency of animal manure, which typically has a more solid consistency for cattle or poultry manure and a more liquid consistency for pig manure. Whereas pig manure is mostly liquid and readily pumpable, bio-solids are not; and, whereas cow and poultry manure are mostly solid and able to be handled using conveyors, conventional broadcast spreader means, etc., bio-solids are not amenable to this either. A truly new land application vehicle and handling system is therefore needed and provided by the present invention. Other examples of semi-solid materials that could benefit from such a vehicle and system include de-watered vegetable processing waste or sludge produced therefrom, drilling mud or debris removed from the drilling of oil or water wells, pulp and paper waste, and the like.

The vehicle may include some or all of the following desirable or advantageous features. The vehicle may allow for either conventional application on top of the soil or incorporation into the soil to reduce the odour and loss of desirable nutrient content through evaporation. The vehicle may be suitable to be pulled by either a truck, for highway transport, or a farm tractor, for application of the bio-solids to the field. The vehicle may be easy to fill, for example through the top of the vehicle, be easy to clean, and not be prone to plugging or sticking of any moving parts. The vehicle may be suitable for use as part of an integrated bio-solids handling system that includes means for loading the vehicle.

According to another aspect of the invention, a new type of loading apparatus is provided in order to facilitate loading of the land application vehicle. The loading apparatus includes an angled elevating chute and a chamber. The elevating chute has a loader chute inlet and a loader chute outlet and contains at least one elevating auger for transferring the semi-solid material up the chute to the loader chute outlet. The chamber is in fluid communication with the loader chute inlet, and has a main portion and a receiving portion. The receiving portion has a floor and a loading wall. The receiving portion is movable between a receiving position wherein the loading wall has a first lift-over height to facilitate loading of the chamber with semi-solid material, and an emptying position wherein the loading wall has a second, relatively higher lift-over height than in the receiving position.

In one embodiment, the chamber may be equipped with a lowerable side that comprises at least an outwardly pivoting portion. The chamber may be equipped with telescoping end plates connected to the lowerable side that together form a receiving chute when pivoted outwardly. In the receiving position, the floor may be at a first angle to horizontal and, in the emptying position, the floor may be at a second angle greater than the first angle. This facilitates loading of the chamber using a dump truck or similar vehicle, since these vehicles typically are not capable of delivering their payloads into a chamber with a high lift-over height. In the emptying position, the loading wall may be oriented to direct semi-solid material generally towards the loader chute inlet.

According to yet another aspect of the invention, the loading apparatus is provided in conjunction with the land application vehicle as part of a semi-solid material handling and land application system. In such a system, the loader chute outlet of the loading apparatus may be positioned relative to a top hopper inlet of the land application vehicle in order to discharge semi-solid material into the land application vehicle.

According to still another aspect of the invention, there is provided a method of operating a land application vehicle having a distributor, which has a distributor inlet and at least one distributor outlet for semi-solid material, comprising: feeding the distributor inlet with a flow of the semi-solid material; transferring semi-solid material away from the distributor inlet towards the at least one distributor outlet; and returning the semi-solid material back towards the distributor inlet.

### BRIEF DESCRIPTION OF THE DRAWINGS

The present invention will now be described by way of example only with reference to the attached drawings, in which:

FIG. 1 is a perspective view of a vehicle for applying bio-solids or other semi-solid material to the ground, in accordance with an embodiment of the present invention;

FIG. 2 is a magnified perspective view of a distributor that is part of the vehicle shown in FIG. 1;

FIG. 3 is a magnified, sectional plan view of the distributor shown in FIG. 2;

FIG. 4 is a magnified sectional side view of the distributor shown in FIG. 2;

FIG. 5 is a plan view from underneath of a portion of the vehicle shown in FIG. 1;

FIG. 6 is a side view of the vehicle shown in FIG. 1;

FIG. 7 is a magnified side view of a portion of the vehicle shown in FIG. 1;

FIG. 8 is a rear elevation view of the vehicle shown in FIG. 1;

FIG. 9 is a perspective view of a semi-solid material handling system including a loader and the vehicle shown in FIG. 1, with a receiving portion in a receiving position; and

FIG. 10 is a perspective view of the semi-solid material handling system shown in FIG. 9, with the receiving portion in an emptying position.

### DETAILED DESCRIPTION OF THE INVENTION

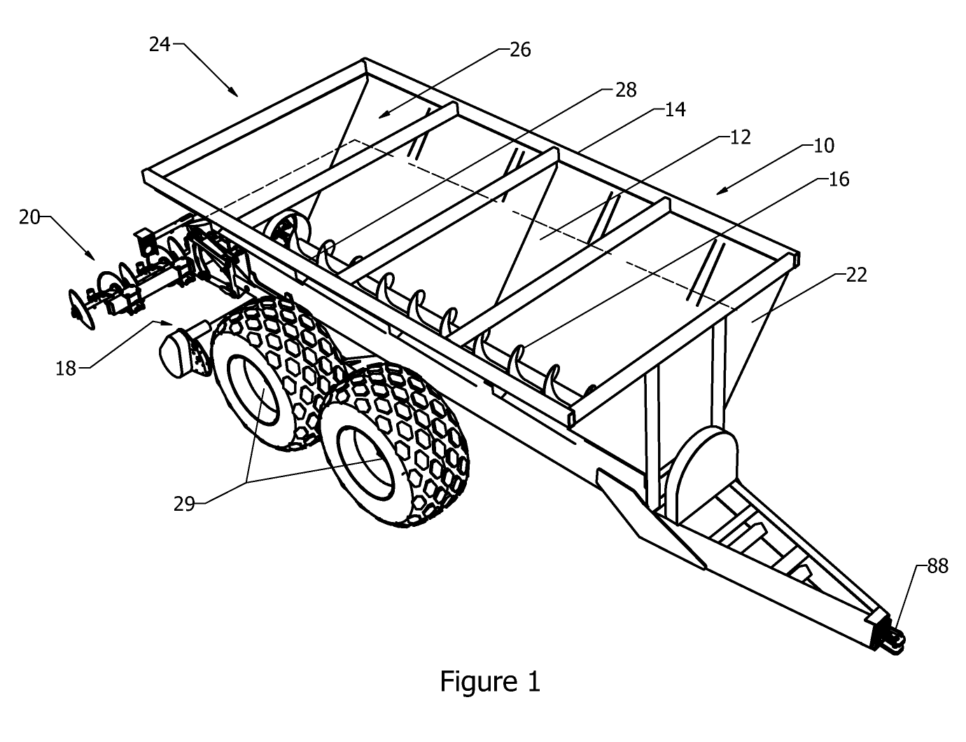

Reference is made to FIG. 1, which shows a vehicle 10 for handling semi-solid material, shown at 12, in accordance with an embodiment of the present invention. The semi-solid material 12 is shown as being transparent in FIG. 1 so as to reveal vehicle structure that would otherwise be hidden. The semi-solid material 12 may be any semi-solid material as previously described, for example bio-solids. Throughout the description, reference is made to bio-solids 12, however, this term may be used interchangeably to describe any suitable semi-solid material. The bio-solids 12/semi-solid material 12 is shown in FIG. 1 and not in any of the other figures so as not to impinge on the clarity of those figures.

The vehicle 10 is used to apply the bio-solids 12 to land and may thus be referred to as a land application vehicle 10. The land application vehicle 10 includes a hopper 14, a longitudinal auger 16 positioned within the hopper 14, a distributor 18, and an optional incorporator 20.

The vehicle 10 has a front 22 and a rear 24. The hopper 14 receives and holds bio-solids 12 to be applied to suitable land, such as agricultural land. The hopper 14 has a hopper inlet 26 for receiving bio-solids that comprises an open top of the hopper 14. The hopper inlet 26 may alternatively be an inlet defined in a closed top to the hopper 14. The hopper 14 has a hopper outlet 28, concealed in FIG. 1 beneath the auger 16, for the release of bio-solid material to the distributor 18. The hopper outlet 28 is positioned at the bottom of the hopper 14.

Although a frame is normally provided beneath the hopper 14, in some embodiments the hopper 14 may act as frame of the vehicle 10 and as such, the other components, such as vehicle wheels shown at 29, the distributor 18 and the incorporator 20 may be connected to the hopper 14, at least indirectly.

The longitudinal auger 16 may be any suitable type of auger, such as, for example, a continuous helical screw auger. The longitudinal auger 16 is positioned at the bottom of the hopper 14 and is configured to convey the bio-solid material 12 toward the hopper outlet 28, which is at the rear 24 of the hopper 14.

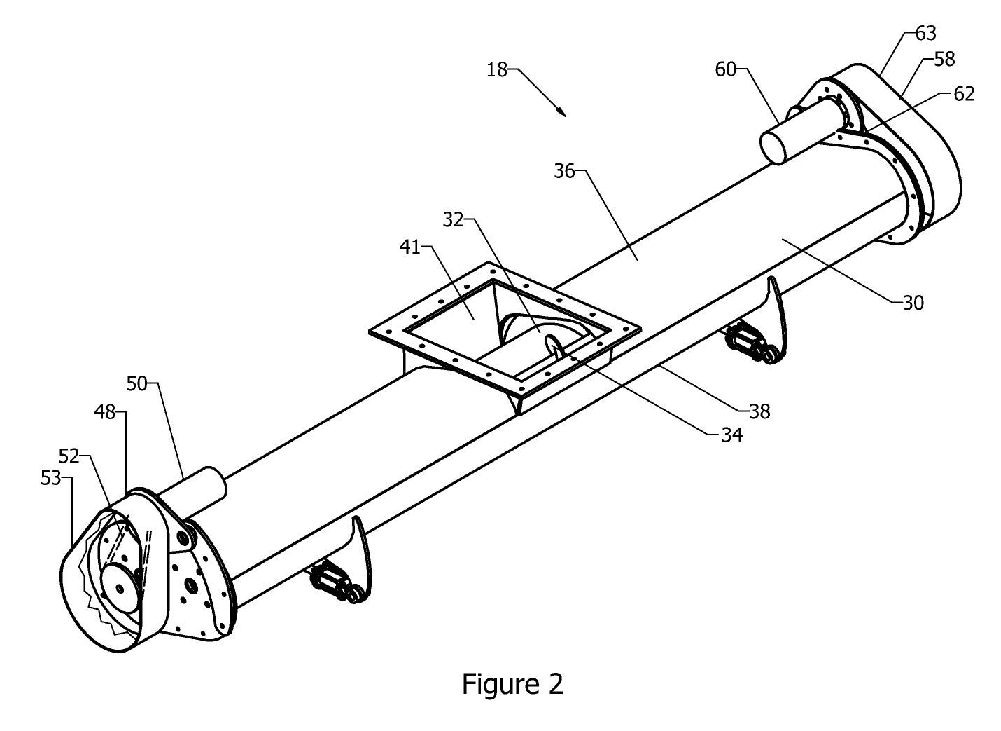

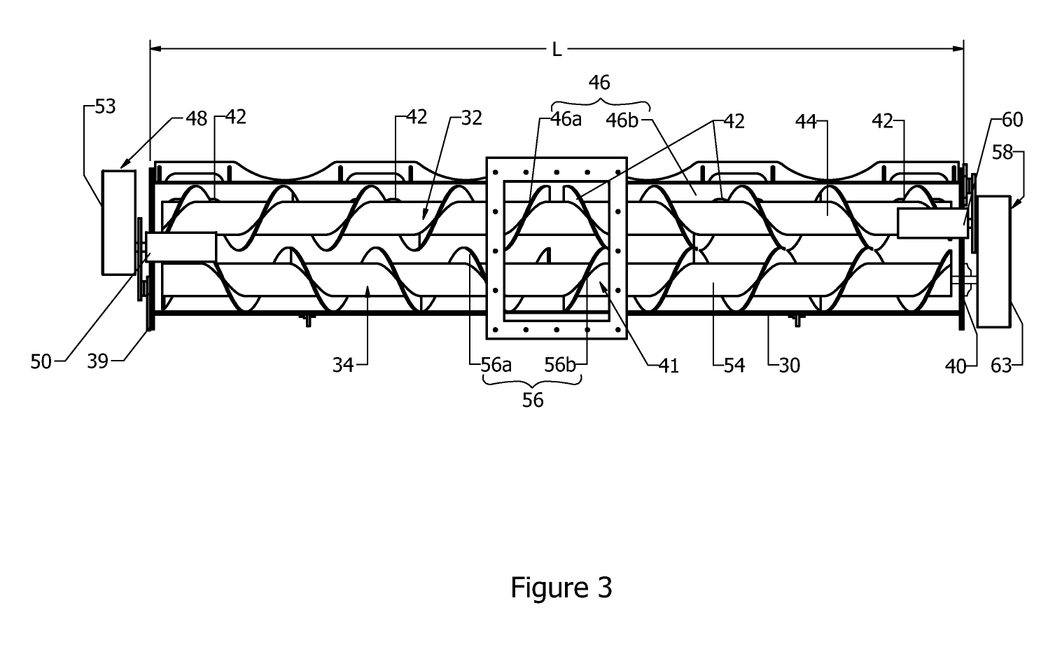

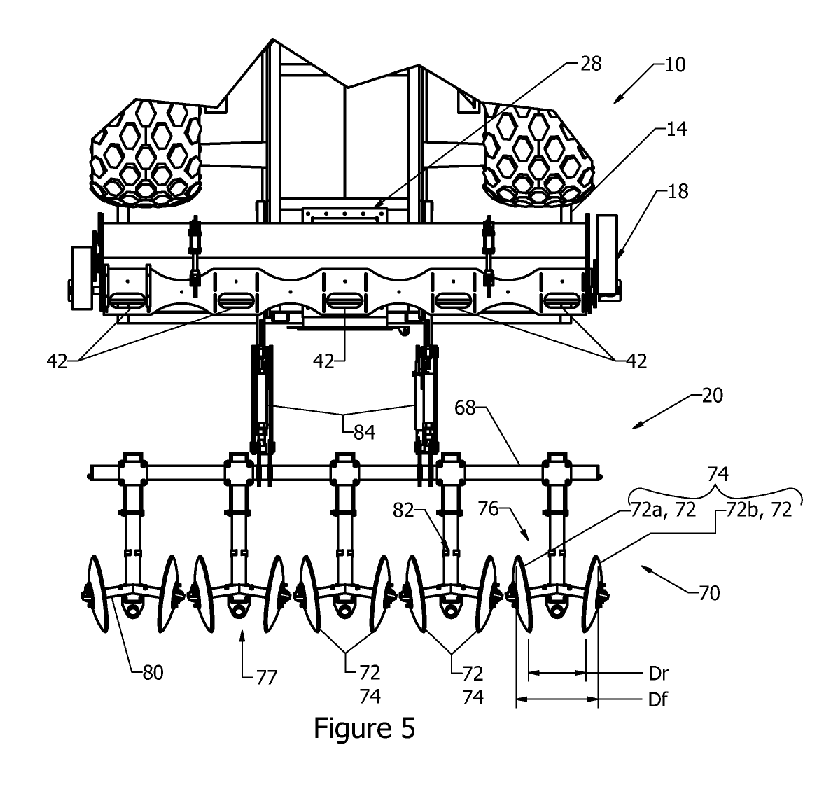

The bio-solid material 12 is discharged from the hopper outlet 28 and into the distributor 18, which is positioned at the rear 24 of the hopper 14. Referring to FIGS. 2-5, the distributor 18 includes a distributor housing 30, a first distributor auger 32 and a second distributor auger 34. The distributor housing 30 has a top 36, a bottom 38, a first end 39, a second end 40 and a transversely oriented length L (FIG. 3). The distributor housing 30 includes a distributor inlet 41 and a plurality of distributor outlets 42 (shown more clearly in FIG. 5). The distributor inlet 41 may be lengthwise centrally positioned along the top 36 (FIG. 2) of the distributor housing 30. The distributor outlets 42 may be evenly spaced along the bottom 38 of the distributor housing 30, with the outermost outlet 42 on each side being positioned proximate an end 39 or 40 of the distributor housing 30. Instead of five distributor outlets 42, any other suitable number of distributor outlets 42 may be provided, such as a single distributor outlet 42. The distributor outlets 42 may have any suitable shape, such as a generally slotted shape.

The first distributor auger 32 has a shaft 44 and a flight 46. The flight 46 may include a first flight portion 46a that is provided with a selected orientation and a second flight portion 46b that is provided with a selected orientation that is opposed to the first flight orientation. Referring to FIG. 2, the first distributor auger 32 may be driven by a first distributor auger drive system 48. A guard 53 is shown in FIG. 2 in cutaway view to illustrate the components covered thereby. The first distributor auger drive system 48 may be any suitable type of drive system, and may include, for example a first hydraulic motor 50 that is operatively connected to the shaft 44 by a drive chain 52. The first hydraulic motor 50 may be operable at fixed speed or at variable speed via a variable valve means or via a hydraulic pump (not shown) whose speed is controllable. In an alternative embodiment, the first hydraulic motor 50 may be some other power source, such as a fixed or variable speed electric motor. In embodiments where the motor 50 rotates at fixed speed, differing gear ratios may be used to alter the rotational speed of the shaft 44. Thus, the first distributor auger 32 rotates at a first distributor auger speed that is selectable.

The distributor outlets 42 are located along the bottom 38 of the housing 30 proximal to and beneath the first auger 32. The orientation of the flight 46 and the direction of rotation of the first distributor auger drive system 48 may be selected so that the first distributor auger 32 is configured to convey bio-solid material 12 (FIG. 1) transversely outwardly, away from the distributor inlet 41 towards the ends of the housing 39, 40. Thus, the first distributor auger 32 is positioned and configured to convey bio-solid material 12 towards all of the distributor outlets 42. The auger 32 can aid in egress of the bio-solids 12 from the distributor outlets 42, or the bio-solids can exit by gravity.

The second distributor auger 34 has a shaft 54 and a flight 56. The flight 56 may include a first flight portion 56a that is provided with a selected orientation that is opposed to the orientation of the first flight portion 46a of the first distributor auger 32, and a second flight portion 56b that is provided with a selected orientation that is opposed to the orientation of the second flight portion 46b of the first distributor auger 32. The flight 56 may thus have the opposite orientation to the flight 46 on the first distributor auger 32. The second distributor auger 32 may be driven by a second distributor auger drive system 58. A guard 63 is shown in FIG. 2 in cutaway view to illustrate the components covered thereby. The second distributor auger drive system 58 may be any suitable type of drive system, and may include, for example a second motor 60 that is operatively connected to the shaft 54 by a drive chain 62. The second hydraulic motor 60 may be operable at fixed or variable speed as previously described with reference to the first hydraulic motor 50. Thus, the second distributor auger 34 rotates at a speed that is selectable.

The second distributor auger 34 is positioned above the first auger 32 and forward of the distributor outlets 42. The orientation of the flight 56 and the direction of rotation of the second distributor auger drive system 48 may be selected so that the second distributor auger 34 is configured to convey bio-solid material 12 (FIG. 1) transversely inwardly from the ends 39, 40 towards the distributor inlet 41. The second distributor auger 34 is therefore positioned and configured to recirculate bio-solids 12 (FIG. 1) that aren't discharged from the distributor outlets 42. This inhibits or prevents the packing of bio-solids 12 at the ends 39 and 40 of the distributor housing 30, thereby reducing the potential for power loss in the distributor 18 and unevenness in the discharge of bio-solids 12 from the distributor outlets 42 that could otherwise result.

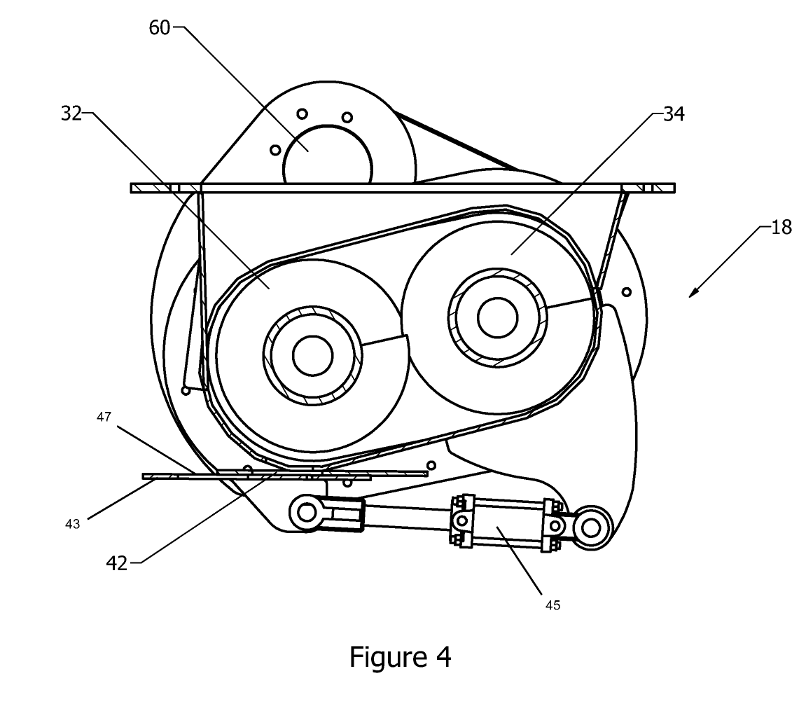

Referring specifically to FIGS. 3 and 4, the flight 56 on the second distributor auger 34 may intermesh with the flight 46 on the first distributor auger 32. In other words, the swept volume of the flight 56 on the second distributor auger may overlap with the swept volume of the flight 46 on the first distributor auger 46. In this case, the rotational speeds of the two augers are fixed relative to one another to prevent interference between the augers. It is not necessary however, that the first and second distributor augers 32 and 34 intermesh with one another. For some bio-solids, they may be positioned in proximity to one another without intermeshing.

In an alternative embodiment (not shown), a single drive system may be provided for both the first and second distributor augers 32, 34. The augers may be geared to one another with a single gear ratio or several selectable gear ratios. This obviates the need for multiple drive motors and allows the distributor augers 32, 34 to rotate at the same speed or different relative speeds.

Multiple parameters relating to the release of bio-solids 12 from the distributor 18 can be at least somewhat independently controlled by providing variable speed capability for at least one of, preferably both of, the first and second distributor augers 32 and 34. In this manner, the overall application rate or flow rate of bio-solids 12 from the distributor 18 can be controlled independently of the distribution of bio-solids 12 across the width of the distributor as they leave through the distributor outlets 42. For example, the speeds of the first and/or second distributor augers 32 and 34 may be selected to achieve a selected overall flow rate of bio-solids 12 from the distributor outlets 42, while maintaining a generally even distribution of bio-solids 12 from the five distributor outlets 42.

As another example, the speeds of the first and/or second distributor augers 32 and 34 can be controlled to provide a selected overall flow rate of bio-solids 12 leaving the distributor outlets 42 while generating a selected amount of shear on the bio-solids 12 to urge them through the distributor outlets 42.

As another example, providing variable speed capability to the first and/or second distributor augers 32 and 34 permits the distributor 18 to be adjusted for the particular physical properties of a particular load of bio-solid material 12 (FIG. 1), such as the stickiness and the water content of the bio-solid material 12, while also controlling other parameters such as overall flow rate from the distributor outlets 42 and the distribution of bio-solids 12 leaving the distributor outlets 42. This is advantageous as the physical properties of the bio-solids 12 may vary from load to load of bio-solid material 12 depending on a variety of factors.

As another example, the variable speed capability for the first and/or second distributor augers 32 and 34 permits the operator to control the distribution of bio-solids 12 leaving the distributor outlets 42, while generating sufficient shear in the bio-solids to urge them through the distributor outlets 42.

It is optionally possible that only one of the distributor augers 32 and 34 be provided with variable speed capability. This would still be advantageous in several respects. For example, variable speed capability on one of the first or second distributor augers 32 or 34 may be used to control the discharge rate of bio-solids 12 from the distributor 18.

It is also optionally possible for neither of the distributor augers 32 and 34 to have variable speed capability.

It is also optionally possible to have the second distributor auger 34 be operated at a faster rotational speed than the first distributor auger 32.

It is also possible for the first and second distributor augers 32, 34 to be operated at the same speed and for that speed to be fixed or variable. This is particularly advantageous when the augers are intermeshing.

As shown in FIG. 4, the distributor outlets 42 may comprise a variable size opening provided by a moveable slide plate 43, powered by an outlet ram 45. By selecting the degree of extension of the ram 45, an aperture 47 in the slide plate 43 can be aligned to a desired degree with the distributor outlet 42 so as to alter the size of the opening provided for egress of bio-solids 12. The size of the outlets 42 may be varied according to the properties of the semi-solid materials/bio-solids 12 or according to the desired application rate. The size of the outlets 42 may be varied in conjunction with a variation in the speed of the first and/or second augers 32, 34. The outlet ram 45 can be replaced by any suitable means of actuating the slide plate 43. A single slide plate 43 may be provided for a plurality of the outlets 42. Alternatively, a separate slide plate 43 and ram 45 may be provided for each outlet 42 or a sub-set of the total number of outlets 42. This is advantageous in that the size of the opening can be varied across the length L of the distributor 18, allowing for better control of the distribution of bio-solids 12 across the length L.

The first distributor auger 32 may be positioned rearward of and below the level of the second distributor auger 34. The rotation of the first distributor auger 34 is such that it pushes the bio-solids 12 downwardly and out through the distributor outlets 42 against the frictional resistance of the distributor housing 30, and pushes upwards on the bio-solids 12 where it interacts with the second distributor auger 34. The distributor outlets 42 may be positioned generally under and slightly behind the first distributor auger 32 so that force of the first distributor auger 32 pushes the bio-solids 12 through the distributor outlets 42. It is alternatively possible, however, for the distributor outlets 42 to be positioned elsewhere in the distributor housing 30. For example, the distributor outlets 42 may be positioned in the end walls of the housing, shown at 64 and 66 in FIG. 3, or may be provided as a smaller number of longer outlets. The outlets 42 may alternatively be provided in the front or rear of the housing 30.

The second distributor auger 34 may co-rotate with the first distributor auger 32 and may thus rotate downwards where it interacts with the first distributor auger 32.

In an alternative embodiment that is not shown, it would be possible to provide the first and second distributor augers 32 and 34 with identical flights instead of oppositely oriented flights, and to counter-rotate the first and second distributor augers 32 and 34.

The distributor 18 is shown in the figures as being generally oriented transversely. It is alternatively possible for the distributor 18 to have some other orientation, such as an orientation that is angled between the transverse and longitudinal directions.

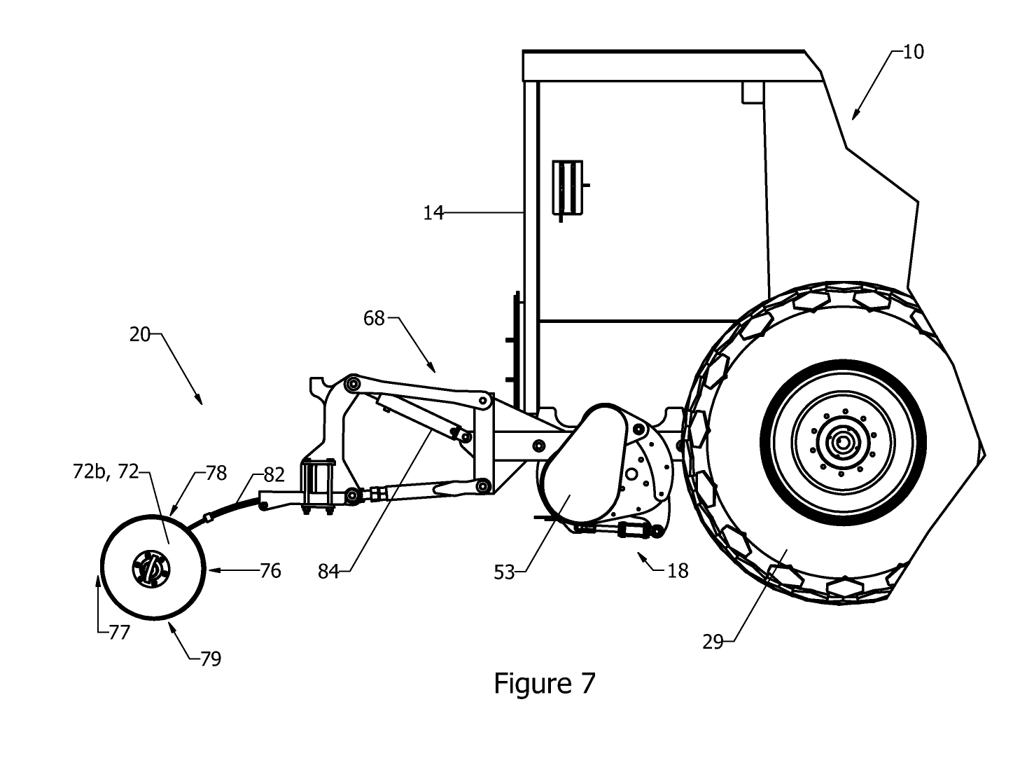

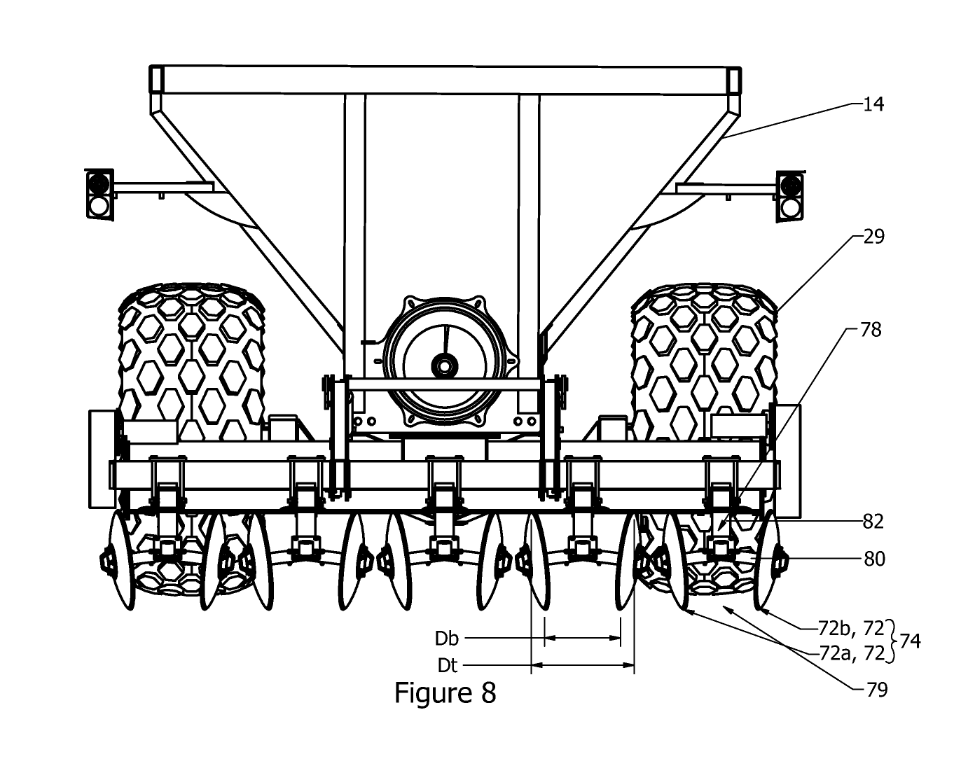

Referring to FIG. 5, the incorporator 20 is positioned rearwardly of the distributor 18. The incorporator 20 includes an articulating frame 68 that is movably connected to the frame beneath the hopper 14, and a plurality of earth working tools 70 mounted to the frame 68 and positioned and configured for covering bio-solids 12 discharged onto the ground through the distributor outlets 42 with earth. The earth working tools 70 may be, for example, coulter wheels 72, and may be arranged in pairs 74, such that a pair 74 of coulter wheels 72 handles semi-solid material 12 discharged from each distributor outlet 42. The coulter wheels may be flat or cupped and may be angled towards one another at the bottom and/or the rear. Each pair 74 of coulter wheels 72 has a front 76, a rear 77, a top 78 (FIG. 7) and a bottom 79. Each pair 74 of coulter wheels 72 includes a first coulter wheel 72a and a second coulter wheel 72b which are spaced laterally from each other. At the front 76, the first and second coulter wheels 72a and 72b have a front spacing Df which is larger than their spacing shown at Dr at the rear 78. By arranging the coulter wheels 72a and 72b in this way, as they roll on the ground they dig into the ground and throw dirt up onto the bio-solids 12 discharged onto the ground from the distributor 18, thereby reducing nutrient loss and odour from the bio-solids 12. Additionally, as shown in FIG. 8, the first and second coulter wheels 72a and 72b may be arranged so that they have a lateral spacing Dt at the top 78 that is greater than their lateral spacing Db at the bottom 79. Having such an arrangement contributes additionally to the effect of throwing dirt onto the bio-solids 12 released from the distributor 18.

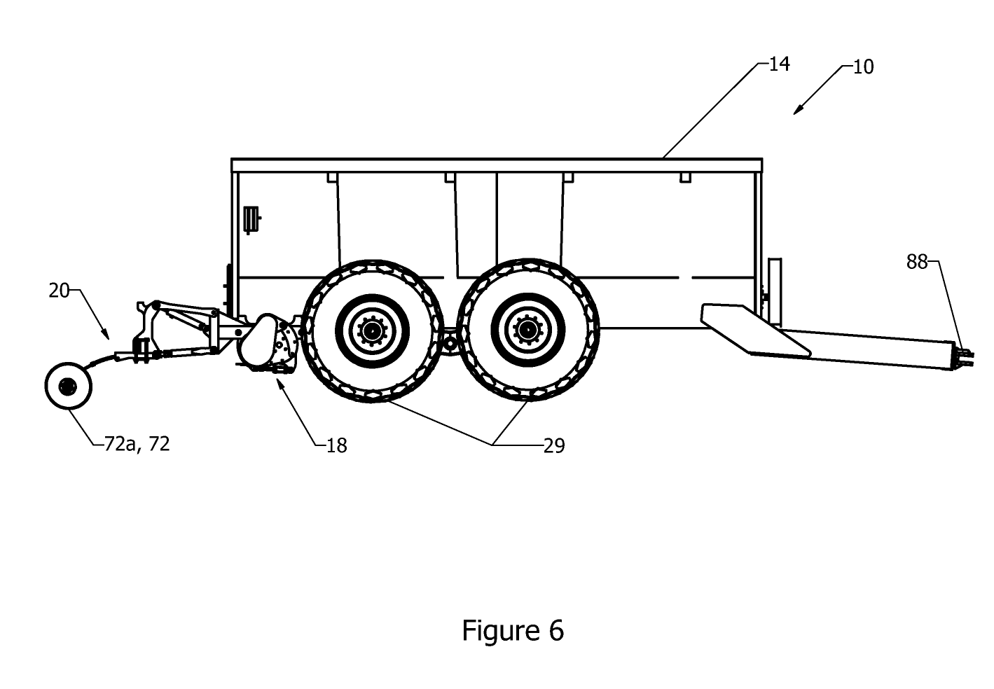

Each pair 74 of coulter wheels 72 may be mounted to an individual sub-frame 80, which may be resiliently mounted to the frame 68 by means of leaf springs 82. The frame 68 may be movable between a raised, ie. non-operating, position (FIG. 6) and a lowered, ie. operating, position (FIG. 7) by means of a pair of hydraulic rams 84 (FIG. 5).

Referring to FIG. 1, a power take off (PTO) shaft 86 is provided for powering the longitudinal auger 16 and optionally the distributor 18 via a hydraulic pump. The distributor 18 can alternatively be powered by a hydraulic pump of a towing vehicle, such as a tractor (not shown). An operator can control the hydraulic components, such as the first and second distributor auger motors 50 and 60, the hydraulic rams 84 for the incorporator 20, and/or the hydraulic outlet rams 45 from the towing vehicle (not shown) during use. A hitch shown at 88 is provided for connection of the land application vehicle 10 to the towing vehicle (not shown). It will be noted, however, that in an alternative embodiment, the land application vehicle 10 may be self-propelled. For example, the hopper 14, longitudinal auger 16, distributor 18 and incorporator 20 may be truck-mounted to a specially configured truck (not shown), in which case the PTO shaft and hydraulic pump could be internal to the vehicle 10.

A land application vehicle having a distributor that has a distributor inlet and at least one distributor outlet, in accordance with an embodiment of the invention, may be operated by the following method: feeding the distributor inlet with a flow of bio-solids, transferring bio-solids away from the distributor inlet towards the distributor outlet, and returning bio-solids back towards the distributor inlet. The steps of transferring bio-solids away from the distributor inlet and returning bio-solids back towards the distributor inlet may be accomplished using first and second distributor augers, respectively. The first distributor auger rotates at a first distributor auger speed and the second distributor auger rotates at a second distributor auger speed. The method may further comprise adjusting at least one of the first and second distributor auger speeds based on the physical properties of the bio-solids, and/or to control the flow rate of bio-solids from the one or more distributor outlets, and/or to control the distribution of bio-solids across the one or more distributor outlets, and/or to control other parameters, such as shear. Optionally, both of the distributor auger speeds are adjusted based on the physical properties of the bio-solids, and/or to control one or more performance parameters of the distributor, such as the flow rate of bio-solids from the one or more distributor outlets or the distribution of bio-solids leaving the distributor outlets.

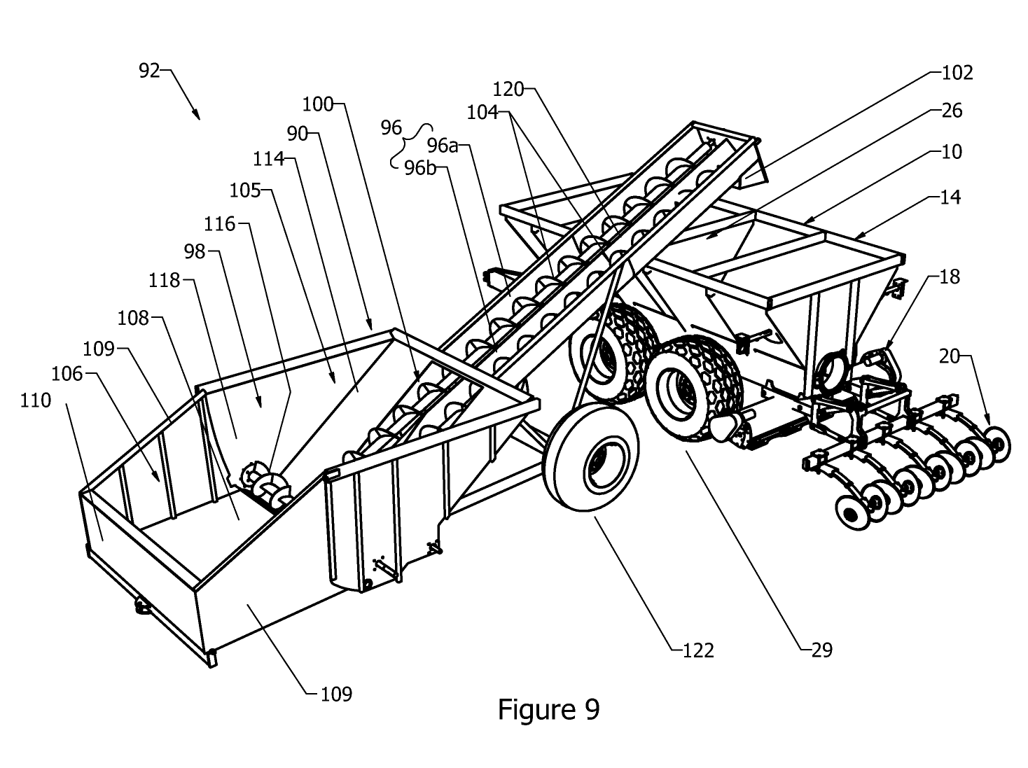

Reference is made to FIG. 9, which shows a loader 90 for loading the land application vehicle 10 with bio-solids 12. Together the loader 90 and land application vehicle 10 make up a semi-solid material handling and land application system 92. The loader 90 includes an angled elevating chute 96 and a chamber 98. The elevating chute 96 has a loader chute inlet 100 and a loader chute outlet 102 and contains two elevating augers 104 for transferring semi-solid material up to the loader chute outlet 102.

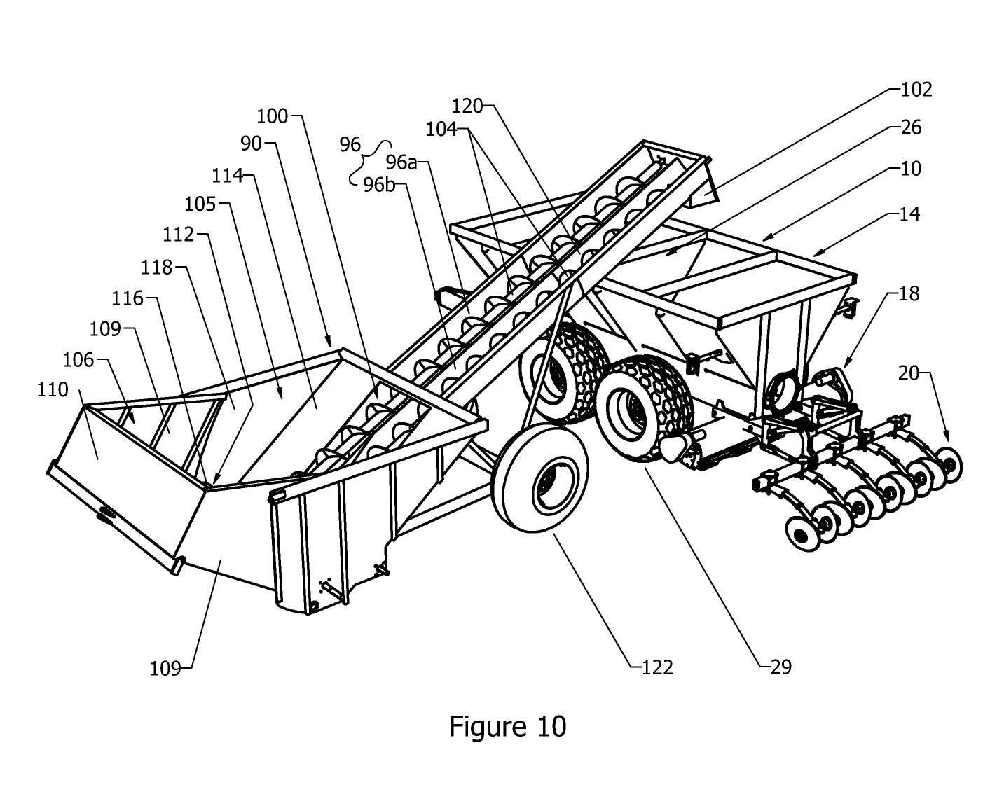

The chamber 98 is in fluid communication with the loader chute inlet 100. The chamber 98 includes a main portion 105 and a receiving portion 106. The receiving portion 106 has a floor 108, a pair of side walls 109 and a loading wall 110, and is movable (for example, by pivoting) between a receiving position shown in FIG. 9 and an emptying position shown in FIG. 10. In the receiving position, the floor 108 may be at a first angle to horizontal that is small and may in fact be generally horizontal. Additionally, in the receiving position, the lift-over height of the loading wall 110 is relatively low. Thus positioned, the receiving portion 106 is relatively easier to load with bio-solids 12 provided from a dump truck or similar low lifting height vehicle.

In the emptying position, (FIG. 10), the floor 108 is positioned at a second angle to horizontal that is relatively greater than the first angle. The floor 108 is angled downwards to form a valley 112 with an opposing end wall 114 of the main portion 105. The loader chute inlet 100 is positioned on the end wall 114 and extends down to the bottom of the valley 112. Thus, the floor 108 may be considered to be oriented to direct bio-solids 12 thereon generally towards the loader chute inlet 100. A loader chute inlet feed conveyor 116 is positioned at the bottom of the valley 112 and conveys bio-solids 12 from the bottom of the valley 112 into the loader chute inlet 100.

The ends of the valley 112 are closed by the side walls 109 of the receiving portion 106 and by side walls of the main portion 105, which are shown at 118. When the receiving portion 106 moves between the receiving and emptying positions, the side walls 109 may slide along the side walls 118 inside of (i.e. adjacent the inner faces of) the side walls 118.

The elevating augers 104 may be similarly flighted and may co-rotate, or alternatively, they may be oppositely flighted and may counter-rotate. The elevating chute 96 may be divided by a divider 120 into two chute portions 96a and 96b, each of which contains an elevating auger 104.

The loader 90 may be movable on wheels 122 into an emptying position wherein the loader chute outlet 102 is positioned above the hopper inlet 26 at the top of hopper 14 of the land application vehicle 10.

The loader 90 may itself be loaded with bio-solids 12 by any suitable means. For example a dump truck (not shown) may be provided as part of the semi-solid material handling and land application system 92.

While the above description constitutes a plurality of embodiments of the present invention, it will be appreciated that the present invention is susceptible to further modification and change without departing from the fair meaning of the accompanying claims.

1) A land application vehicle for semi-solid material, comprising:
a) a hopper having a hopper inlet and a hopper outlet; and,
b) a distributor having a transversely oriented length comprising a housing having a distributor inlet, for receiving semi-solid material from the hopper, and at least one distributor outlet, a first distributor auger in the housing for transferring semi-solid material away from the distributor inlet and a second distributor auger in the housing for returning semi-solid material back towards the distributor inlet.

2) The vehicle of claim 1, wherein the vehicle has a front and a rear, the hopper outlet is at the rear and the distributor is located at the rear.

3) The vehicle of claim 2, further comprising a longitudinal auger within the hopper for transferring the semi-solid material toward the hopper outlet.

4) The vehicle of claim 1, wherein the distributor inlet is in fluid communication with the hopper outlet and wherein the hopper outlet is in a bottom of the hopper.

5) The vehicle of claim 1, wherein the distributor inlet is centrally positioned along the length.

6) The vehicle of claim 1, wherein the distributor inlet is in fluid communication with both the first and second distributor augers.

7) The vehicle of claim 1, wherein only the first distributor auger is positioned within the housing and configured for transferring the semi-solid materials towards the distributor outlet.

8) The vehicle of claim 1, wherein the first distributor auger is rearward of the second distributor auger.

9) The vehicle of claim 1, wherein the first distributor auger is below the second distributor auger.

10) The vehicle of claim 1, wherein the first and second distributor augers are intermeshing.

11) The vehicle of claim 1, wherein the first and second distributor augers are flighted in opposite directions.

12) The vehicle of claim 11, wherein the first and second distributor augers co-rotate.

13) The vehicle of claim 1, wherein each auger has a rotational speed and wherein the first and second distributor augers are rotatable at different speeds.

14) The vehicle of claim 13, wherein the rotational speed of the second distributor auger is greater than the rotational speed of the first distributor auger.

15) The vehicle of claim 13, wherein the rotational speed of each auger is separately adjustable.

16) The vehicle of claim 15, wherein the rotational speed of the first distributor auger is selected to provide an approximately even distribution of the semi-solid material along the length and wherein the rotational speed of the second distributor auger is selected to inhibit packing of semi-solid material within the distributor.

17) The vehicle of claim 1, wherein the at least one distributor outlet comprises a plurality of discrete distributor outlets.

18) The vehicle of claim 17, wherein the plurality of distributor outlets are located in a bottom of the distributor.

19) The vehicle of claim 17, wherein the plurality of distributor outlets are located proximal the first distributor auger.

20) The vehicle of claim 1, wherein the vehicle further includes a soil incorporator located rearward of the distributor.

21) The vehicle of claim 20, wherein the incorporator includes a plurality of earth working tools positioned and configured for covering semi-solid material discharged onto the ground through the distributor outlets with earth.

22) The vehicle of claim 21, wherein the plurality of earth working tools are a plurality of coulter wheels.

23) The vehicle of claim 22, wherein the plurality of coulter wheels include at least one pair of coulter wheels, including a first coulter wheel and a second coulter wheel, wherein the at least one pair of coulter wheels have a front and a rear, wherein at the front of the at least one pair of coulter wheels is a front spacing between the first and second coulter wheels, and wherein at the rear of the at least one pair of coulter wheels is a rear spacing between the first and second coulter wheels that is less than the front spacing.

24) The vehicle of claim 23, wherein the at least one pair of coulter wheels have a top and a bottom, wherein at the top of the at least one pair of coulter wheels is a top spacing between the first and second coulter wheels, and wherein at the bottom of the at least one pair of coulter wheels is a bottom spacing between the first and second coulter wheels that is less than the top spacing.

25) A loading apparatus for handling semi-solid material, comprising:
a) an angled elevating chute having a loader chute inlet and a loader chute outlet and containing at least one elevating auger for transferring the semi-solid material up the chute to the loader chute outlet; and,
b) a chamber in fluid communication with the loader chute inlet, wherein the chamber has a main portion and a receiving portion, the receiving portion having a floor and a loading wall, wherein the receiving portion is movable between a receiving position wherein the loading wall has a first lift-over height to facilitate loading of the chamber with semi-solid material, and an emptying position wherein the loading wall has a second, relatively higher lift-over height than in the receiving position.

26) The loading apparatus of claim 25, wherein the elevating chute and the chamber each have an open top.

27) The loading apparatus of claim 25, wherein the at least one elevating auger comprises first and second elevating augers.

28) The loading apparatus of claim 27, wherein the elevating augers are flighted in the same direction and co-rotate.

29) The loading apparatus of claim 25, wherein the receiving portion pivots between the receiving and emptying positions.

30) The loading apparatus of claim 29, wherein, in the receiving position, the floor is at a first angle to horizontal and wherein, in the emptying position, the floor is at a second angle greater than the first angle.

31) The loading apparatus of claim 29, wherein, in the emptying position, the loading wall is oriented to direct semi-solid material thereon towards the loader chute inlet.

32) The loading apparatus of claim 25, wherein, in the emptying position, the floor forms a valley with an opposing end wall of the main portion and wherein the loading apparatus further comprises a loader chute inlet feed conveyor that is positioned in the valley to convey semi-solid material received from the receiving portion towards the at least one elevating auger.

33) The loading apparatus of claim 25, wherein the receiving portion includes a pair of receiving portion side walls, wherein the main portion includes a pair of main portion side walls, wherein the receiving portion side walls slide along the main portion side walls during movement of the receiving portion between the receiving and emptying positions.

34) A semi-solid material handling and land application system comprising:
a) a loading apparatus including:
i) an angled elevating chute having a loader chute inlet and a loader chute outlet and containing at least one elevating auger for transferring semi-solid material up the chute to the loader chute outlet; and,
ii) a chamber in fluid communication with the loader chute inlet, wherein the chamber has a main portion and a receiving portion, the receiving portion having a floor and a loading wall, wherein the receiving portion is movable between a receiving position wherein the loading wall has a first lift-over height to facilitate loading of the chamber with semi-solid material, and an emptying position wherein the loading wall has a second, relatively higher lift-over height than in the receiving position;
b) a land application vehicle including:
i) a hopper having a top hopper inlet and a hopper outlet; and,
ii) a distributor having a transversely oriented length and a housing having a distributor inlet in fluid communication with the hopper outlet, for receiving semi-solid material from the hopper, and at least one distributor outlet;
and, wherein the loader chute outlet is positioned relative to the land application vehicle to discharge semi-solid material into the hopper inlet.

35) The system of claim 34, wherein the receiving portion pivots between the receiving and emptying positions.

36) The system of claim 34, wherein the chamber is loadable by a dump truck in the receiving position.

37) The system of claim 34, wherein the receiving portion includes a pair of receiving portion side walls, wherein the main portion includes a pair of main portion side walls, and wherein the receiving portion side walls slide along the main portion side walls during movement of the receiving portion between the receiving and emptying positions.

38) A method of operating a land application vehicle having a distributor having a distributor inlet and at least one distributor outlet, comprising:
a) feeding the distributor inlet with a flow of the semi-solid material;
b) transferring semi-solid material away from the distributor inlet towards the at least one distributor outlet; and
c) returning the semi-solid material back towards the distributor inlet.

39) The method of claim 38, wherein step b) is carried out using a first distributor auger rotatable at a first distributor auger speed, and step c) is carried out using a second distributor auger rotated at a second distributor auger speed.

40) The method of claim 39, wherein the method further comprises adjusting at least one of the first or second distributor auger speeds based on the physical properties of the semi-solid material.

41) The method of claim 39, wherein the method further comprises adjusting at least one of the first or second distributor auger speeds to control the flow rate of semi-solid material from the at least one distributor outlet.

42) The method of claim 39, wherein the at least one distributor outlet is a plurality of distributor outlets, and wherein the method further comprises adjusting at least one of the first or second distributor auger speeds to control the distribution of semi-solid material from the distributor outlets.

43) The method of claim 39, wherein the method further comprises adjusting the first and second distributor auger speeds based on the physical properties of the semi-solid material.

44) The method of claim 39, wherein the at least one distributor outlet is a plurality of distributor outlets, and wherein the method further comprises adjusting the first and second distributor auger speeds based on the physical properties of the semi-solid material and to control the flow rate of the semi-solid material from the distributor outlets.
